(19) United States
(12) Patent Application Publication
(10) Pub. No.: US 2013/0130877 A1
(43) Pub. Date: May 23, 2013

(54) Paper Box Forming Machine

(71) Applicant: Shun-Fa Su, Kaohsiung (TW)

(72) Inventor: Shun-Fa Su, Kaohsiung (TW)

(21) Appl. No.: 13/299,432

(22) Filed: Nov. 18, 2011

(51) Int. Cl. B31B 1/28

(52) U.S. Cl. 493/175

(57) ABSTRACT

A paper box forming machine includes a machine body and a mandrel rotatably mounted around an axle of the machine body. A pressing device movable relative to the mandrel includes a frame having upper and lower portions and first and second side portions extending between the upper and lower portions. A tunnel extends from the first side portion through the second side portion and has a size larger than the mandrel. A pressing plate is provided to an inner side of each of the upper and lower portions and the first and second side portions. The pressing plates are actuatable to move relative to and in the frame to exert pressure on an outer periphery of the mandrel to make a paper box body from a corrugated paper layer wound around the outer periphery of the mandrel.

### BACKGROUND OF THE INVENTION

The present invention relates to a paper box forming machine and, more particularly, to a machine for forming an integral paper box including four sidewalls without seams.

FIG. 15 shows a conventional paper box 10 integrally formed of corrugated paper 12 and having four sidewalls Top and bottom covers 16 and 18 are mounted to top and bottom ends of paper box 10 so that paper box 10 can receive goods. Since four sidewalls 14 of paper box 10 have no seams, paper box 10 has higher strength.

Formation of the integral paper box includes winding corrugated paper around a mandrel and then pressing the mandrel. Taiwan Utility Model Publication No. 533989 discloses an apparatus including a mandrel and a frame for making an integral paper box. The mandrel is comprised of at least two mandrel parts that can be operated to move towards or away from each other. Corrugated paper is wrapped around the mandrel a plurality of rounds. A channel extends through the frame and receives the mandrel. At least one base mold seat and at least one movable mold seat are mounted around the channel. The movable mold seat can be operated to press against the mandrel in the channel so that the rounds of the corrugated paper around the mandrel bond with each other. Then, the integral corrugated paper is separated from the mandrel.

Although the apparatus is complicated and slow, although it can make the integral paper box. Furthermore, a flat sheet must be fixed by a tape to an outer periphery of the mandrel before wrapping the corrugated paper around the mandrel so as to make a wavy sheet applied with glue engage with the flat sheet. The tape adhered to the mandrel interferes with ejection of the paper box after formation.

### BRIEF SUMMARY OF THE INVENTION

An objective of the present invention is to provide a paper box forming machine that has simple structure and that can rapidly make an integral paper box.

A paper box forming machine includes a machine body having an axle extending along a longitudinal axis. A mandrel is rotatably mounted around the axle and includes an outer periphery surrounding the longitudinal axis. A corrugated paper layer is adapted to be wound around the outer periphery of the mandrel. A pressing device is movable relative to the mandrel along the longitudinal axis. The pressing device includes a frame having upper and lower portions. The frame further includes first and second side portions extending between the upper and lower portions. A tunnel extends from the first side portion through the second side portion along the longitudinal axis. The tunnel has a size larger than the mandrel. A pressing plate is provided to an inner side of each of the upper and lower portions and the first and second side portions. The pressing plates are actuatable to move relative to and in the frame to exert pressure on the outer periphery of the mandrel. When the corrugated paper layer is wound around the outer periphery of the mandrel, the pressing device is moved to a position in which the mandrel is received in the tunnel of the frame. The pressing plates are actuated to exert pressure on the outer periphery of the mandrel to make a paper box body from the corrugated paper layer wound around the outer periphery of the mandrel.

In a form shown, the pressing device further includes four pressing rods provided in four corners of the tunnels of the frame. Each pressing rod is actuatable to move in the frame to exert pressure on four corners of the mandrel, forming a recessed portion on each of four corners of the paper box body.

The pressing device can further include a pull plate located on a front end of at least one of the pressing plates. The pull plate comes in contact with the paper box body while the pressing device is moving away from the mandrel, causing ejection of the paper box body from the mandrel.

In the form shown, the mandrel includes a mandrel body and four panels on four sides of the mandrel body. The corrugated paper layer is adapted to be wound around the four panels. The axle includes front and rear sections spaced along the longitudinal axis. The axle includes a longitudinal hole extending from the front section through the rear section. The front section includes a plurality of through-holes in communication with the longitudinal hole. The rear section of the axle is connected by a pipe to a pump. The pipe is in communication with the longitudinal hole.

In the form shown two spaced bearings are provided on the front section of the axle. A sleeve is received in the mandrel body and mounted around the two bearings. The sleeve includes a plurality of through-holes extending in a radial direction perpendicular to the longitudinal axis. One of the four panels includes a plurality of vents. The mandrel further includes a plurality of air suction pipes each having two ends mounted to an inner side of the one of the four panels having the vents. Each of the two ends of each of the plurality of air suction pipes has an air suction hole in communication with the plurality of vents. A connection section extends from each of the plurality of air suction pipes and is in communication with one of the through-holes of the sleeve. When the pump operates, suction force is provided to an outer side of the panel having the vents through the through-holes of the axle and the plurality of air suction pipes.

In the form shown, the machine body includes a bottom having two spaced tracks each extending along the longitudinal axis. The pressing device is mounted on and movable along the two tracks.

In the form shown, each of the pressing plates includes a plane inner face and an outer face opposite to the inner face. The outer face of each pressing plate is operably connected to and actuatable by an actuating rod of a driving unit. The driving units actuate the pressing plates to move in the frame and to exert pressure on the outer periphery of the mandrel.

The present invention will become clearer in light of the following detailed description of illustrative embodiments of this invention described in connection with the drawings.

### DESCRIPTION OF THE DRAWINGS

FIG. 1 shows a perspective view of a paper box forming machine according to the present invention.

FIG. 2 shows a perspective view of the machine of FIG. 1, with a pressing device moved to a position receiving a mandrel.

FIG. 3 shows a cross sectional view of the machine of FIG. 1, with a paper box body formed.

FIG. 4 shows a partial, perspective view of the machine of FIG. 1, with portions broken away.

FIG. 5 shows an exploded, perspective view of the mandrel.

FIG. 6 shows a partial, cross sectional view of the machine of FIG. 1.

FIG. 7 shows winding of a corrugated paper layer around a mandrel body.

FIG. 8 shows an exploded, perspective view of the pressing device.

FIG. 9 shows a cross sectional view of the machine of FIG. 1, with a flat sheet wound around the mandrel body.

FIG. 10 shows a view similar to FIG. 9, with the corrugated paper layer wound around the mandrel body.

FIG. 11 shows a view similar to FIG. 10, with pressing plates of the pressing device moved inwards.

FIG. 12 shows a view similar to FIG. 11, with pressing rods of the pressing device moved inwards.

FIG. 13 shows a view similar to FIG. 12, with the pressing plates and the pressing rods moved backwards.

FIG. 14 shows a perspective view of a paper box body formed by the machine of FIG. 1.

FIG. 15 shows a perspective view of a conventional paper box.

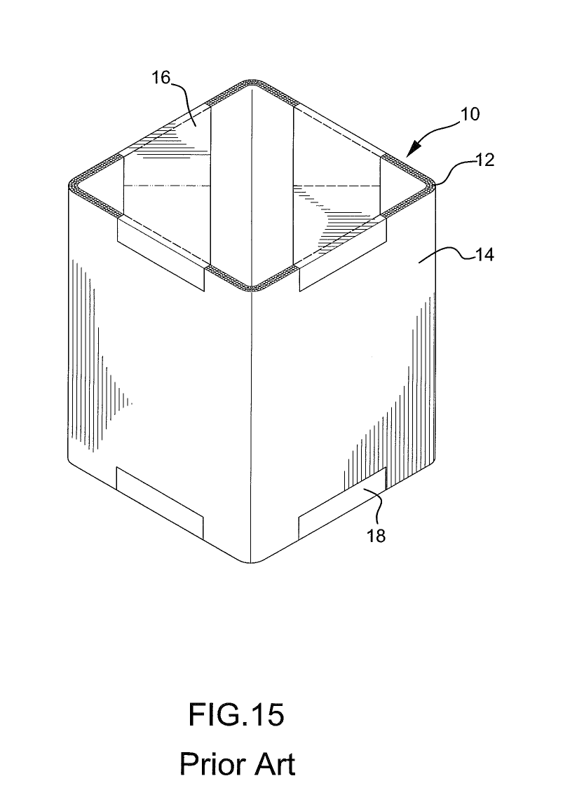

### DETAILED DESCRIPTION OF THE INVENTION

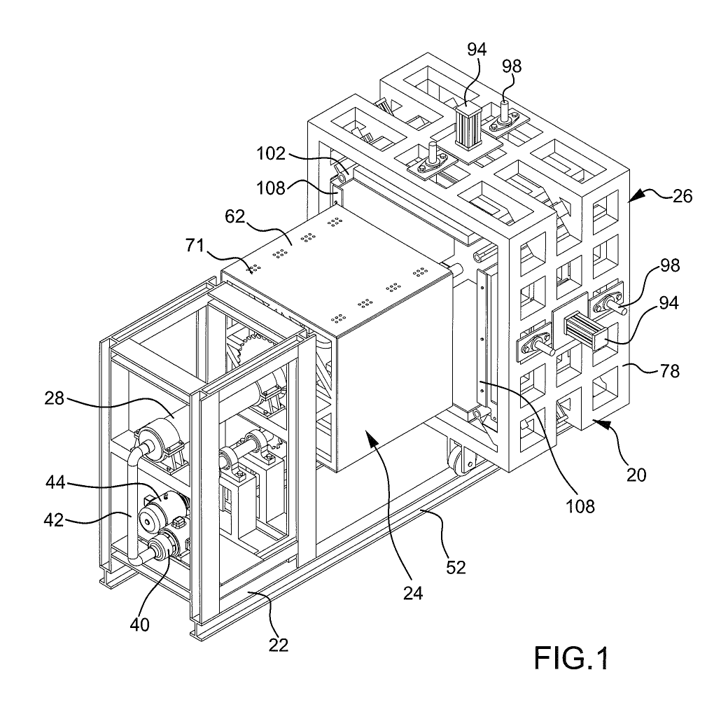

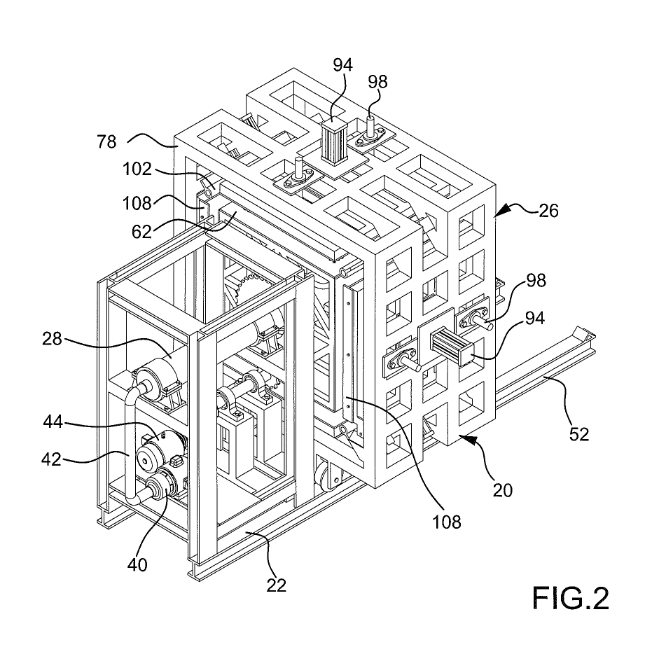

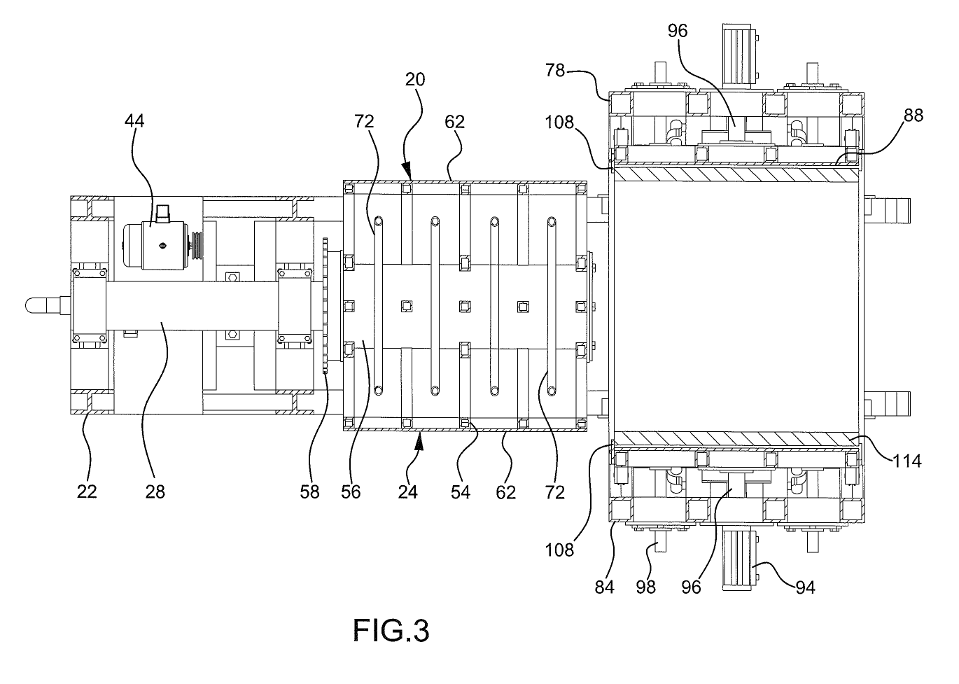

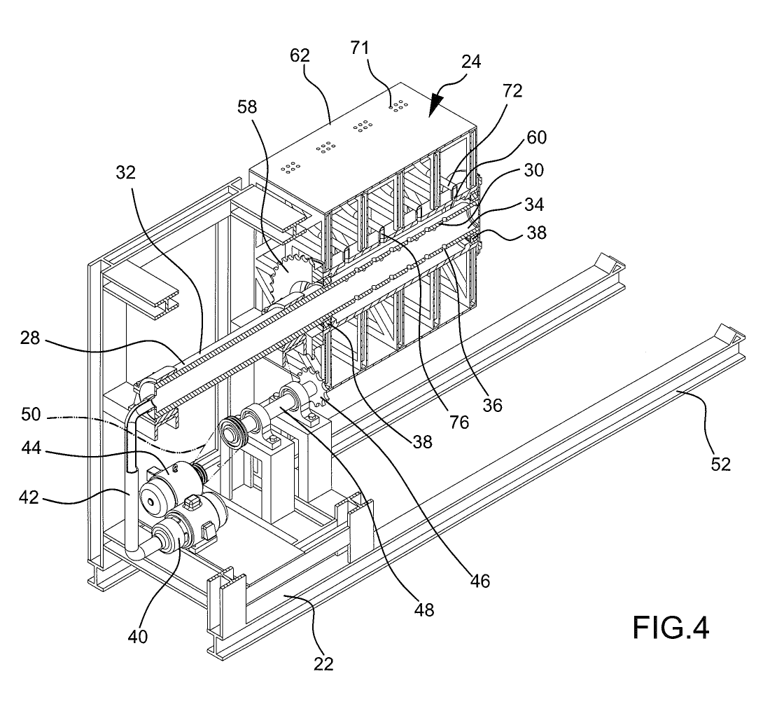

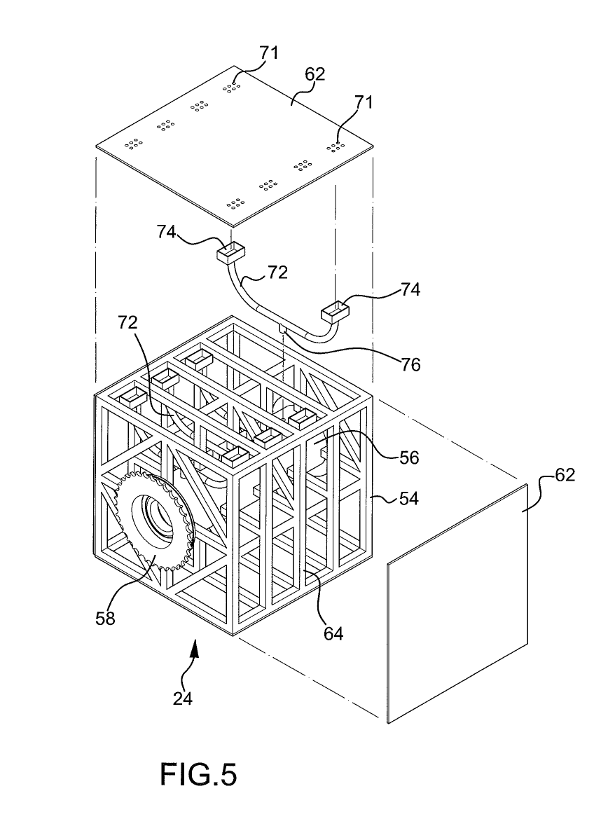

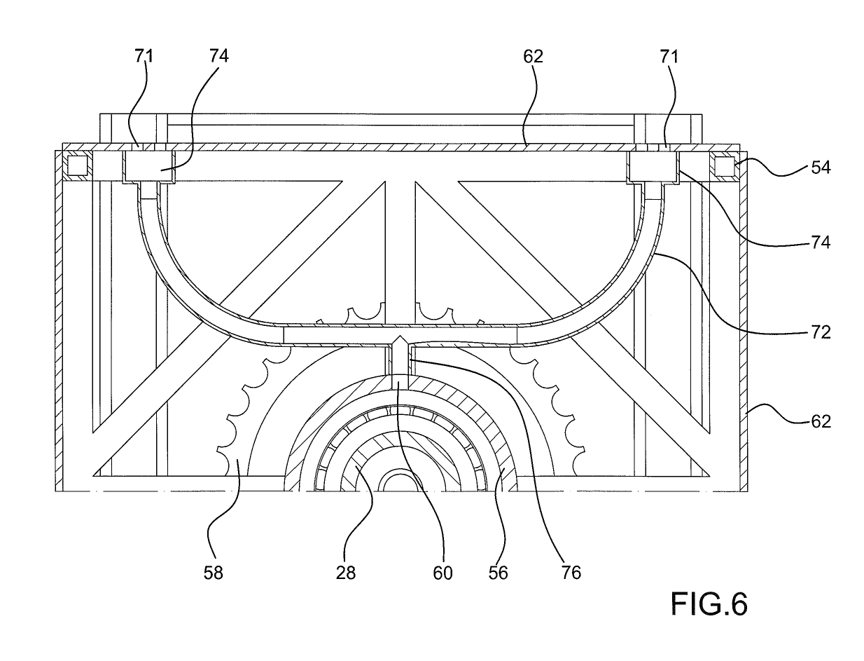

With reference to FIGS. 1-6, a paper box forming machine 20 according to the present invention includes a machine body 22, a mandrel 24, and a pressing device 26 movable relative to mandrel 24.

Machine body 22 includes a hollow axle 28 having front and rear sections 30 and 32 spaced along a longitudinal axis. Axle 28 includes a longitudinal hole 34 extending from front section 30 through rear section 32. Front section 30 includes a plurality of through-holes 36 in communication with longitudinal hole 34. Two bearings 38 are provided on front section 30 of axle 28 and spaced along the longitudinal axis. Rear section 32 has a distal end connected by a pipe 42 to a pump 40. Pipe 42 is in communication with the longitudinal hole 34. When pump 40 operates, air outside of axle 28 is sucked into longitudinal hole 34 via through-holes 36 of axle 28. Machine body 22 further includes a power device 44 such as a motor. Power device 44 is operably connected to a driving gear 46. In the form shown, driving gear 46 is mounted on a transmission shaft 48 that is connected by a belt or chain 50 to power device 44. Machine body 22 includes a bottom having two spaced tracks 52 each extending along the longitudinal axis.

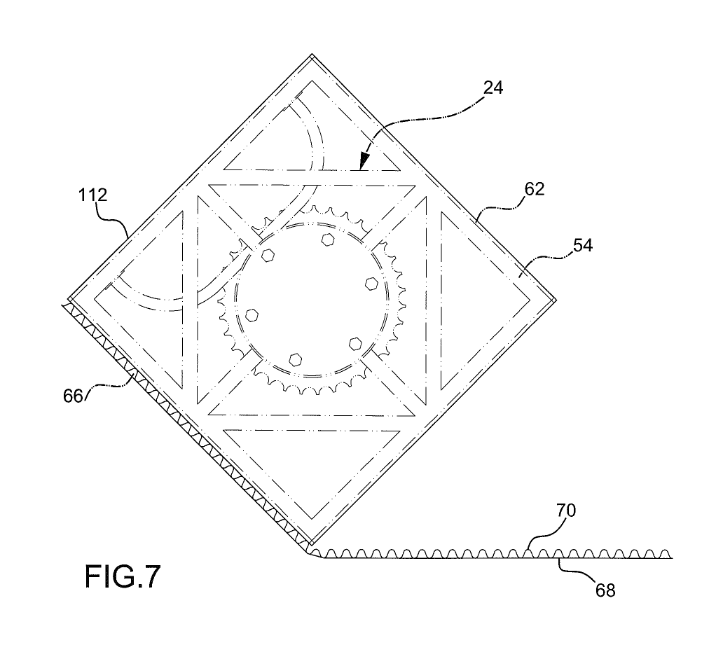

Mandrel 24 is rotatably mounted around axle 28. In the form shown, mandrel 24 includes a cubic mandrel body 54 and a sleeve 56 received in mandrel body 54. Sleeve 56 extends along the longitudinal axis and is mounted around bearings 38 on front section 30 of axle 28. Sleeve 56 includes a plurality of through-holes 60 extending in a radial direction perpendicular to the longitudinal axis. A driven wheel 58, such as a sprocket, is mounted on an end of sleeve 56 and connected by a chain to driving wheel 46. Thus, mandrel 24 can be driven by power device 44 to rotate. Mandrel 24 further includes four panels 62 on four sides 64 of mandrel body 54. Thus, an elongated corrugated paper layer 66 can be wound around panels 62 of mandrel 24 (FIG. 7). Corrugated paper layer 66 includes a flat sheet 68 and a wavy sheet 70 bonded to a side of flat sheet 68. One of panels 62 includes a plurality of vents 71. Mandrel 24 further includes a plurality of air suction pipes 72 each having two ends mounted to an inner side of the panel 62 having vents 71. Each end of each air suction pipe 72 has an air suction hole 74 in communication with vents 71. A connection section 76 extends from each air suction pipe 72 and is in communication with one of through-holes 60 of sleeve 56. When pump 40 operates, suction force is provided to an outer side of panel 62 having vents 71 through through-holes 36 of axle 28 and air suction pipes 72.

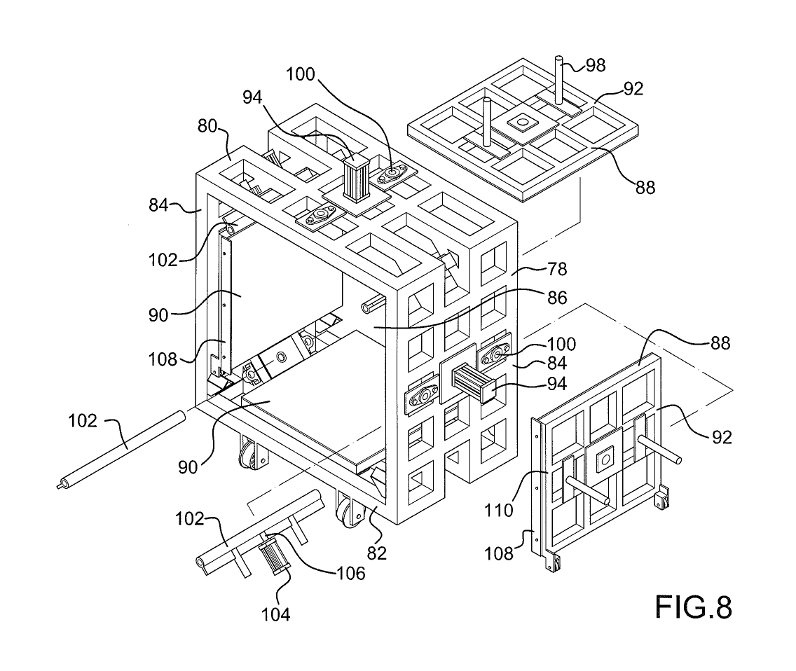

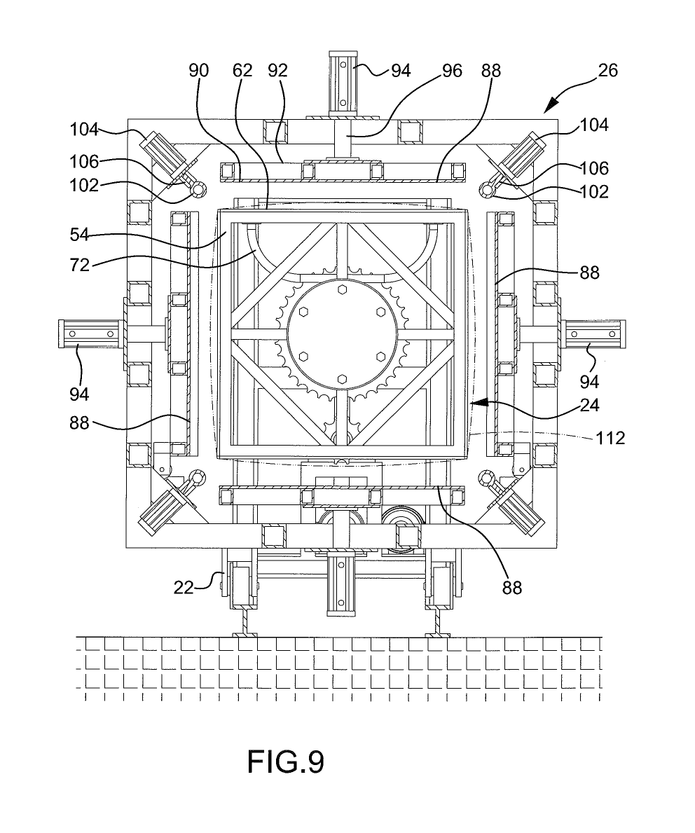

With reference to FIGS. 8 and 9, pressing device 26 is mounted on and movable along tracks 52. Pressing device 26 includes a frame 78 having rectangular cross sections. Frame 78 includes upper and lower portions 80 and 82 and first and second side portions 84 extending between upper and lower portions 80 and 82. A tunnel 86 extends from first side portion 84 through second side portion 84 along the longitudinal axis and has rectangular cross sections. Tunnel 86 has a size larger than mandrel 24. A pressing plate 88 is provided to an inner side of each of upper and lower portions 80 and 82 and first and second side portions 84. Each pressing plate 88 includes a plane inner face 90 and an outer face 92 opposite to inner face 90. Outer face 92 of each pressing plates 88 is operably connected to and actuatable by an actuating rod 96 of a first driving unit 94. First driving units 94 actuate pressing plates 88 to move in frame 78 and to exert pressure on the outer periphery of mandrel body 54. First driving units 94 can be pneumatic or hydraulic cylinders and respectively mounted on upper and lower portions 80 and 82 and first and second side portions 84. Two guiding rods 98 are provided on outer face 92 of each pressing plate 88 and extended through guiding holes 100 in frame 78 so that pressing plates 88 can move stably.

In the form shown, pressing device 26 further includes four pressing rods 102 provided in four corners of tunnels 86 of frame 78. Each pressing rod 102 is in the form of a cylinder and connected to an actuating rod 106 of a second driving unit 104. Each pressing rod 102 can be actuated by a corresponding second driving unit 104 to move in frame 78 and to exert pressure on one of four corners of mandrel body 54. Each corner of mandrel body 54 is the adjoining area of two adjacent panels 62. Pressing device 26 further includes two pull plates 108 provided on front ends 110 of pressing plates 88 that are located on upper and lower portions 80 and 82 or located on first and second side portions 84.

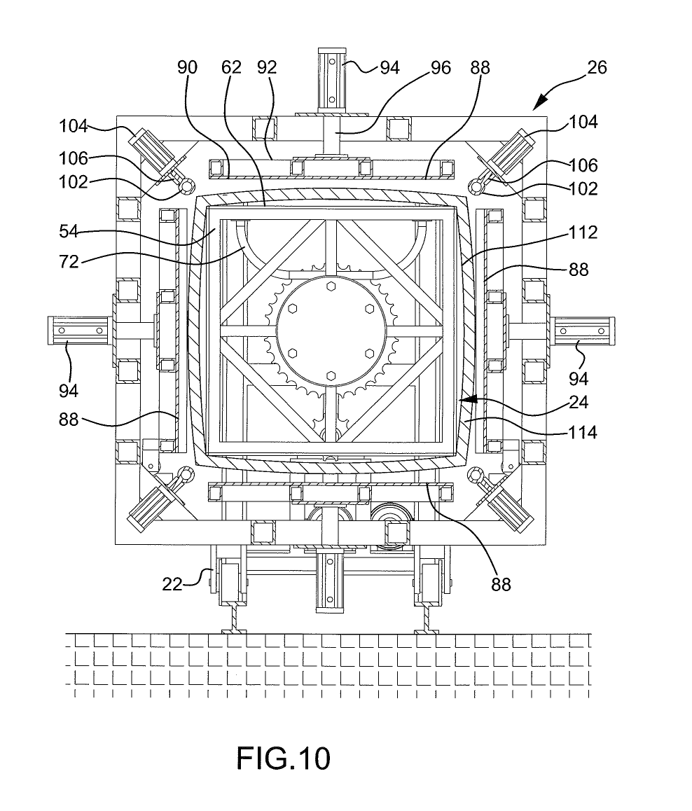

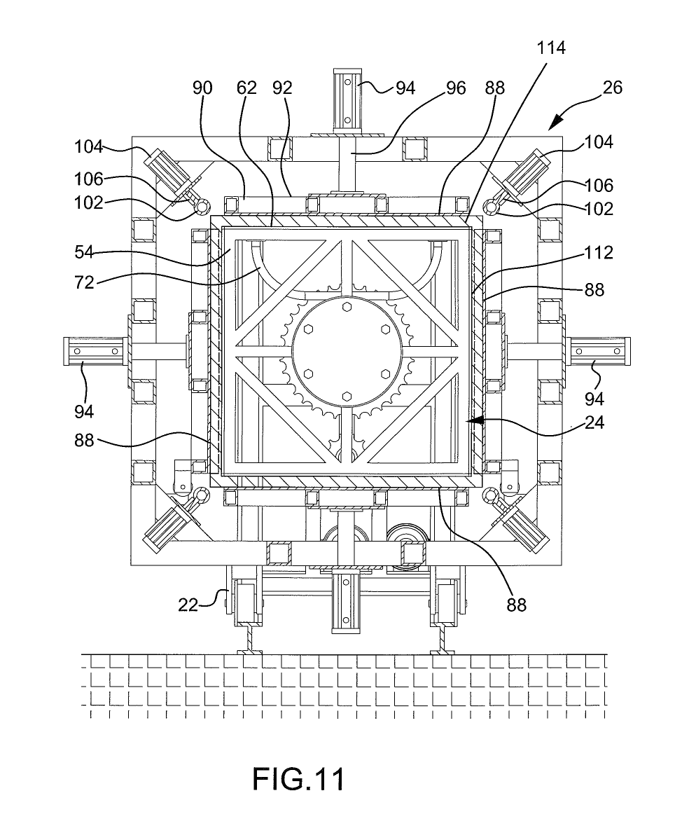

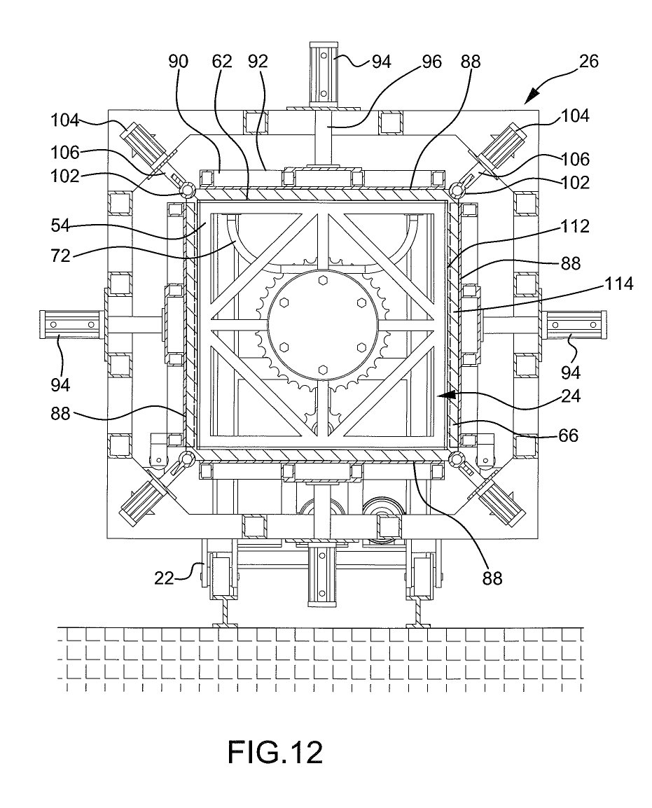

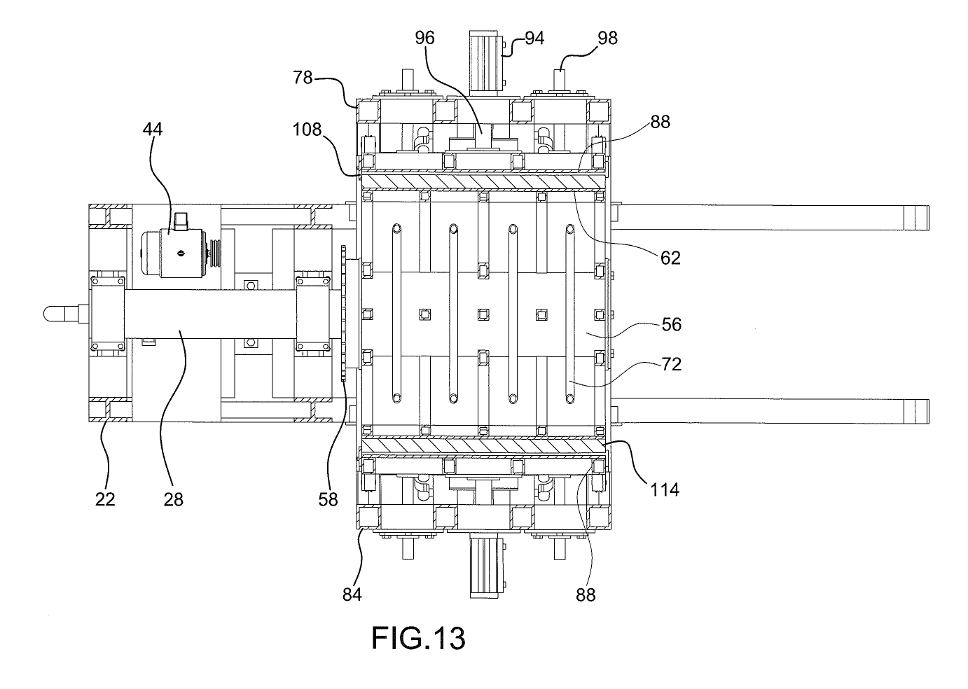

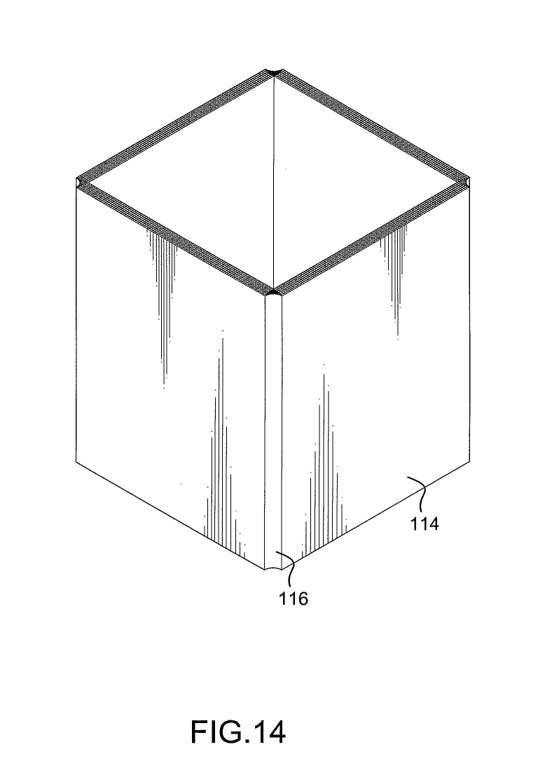

In operation of paper box forming machine 20, a flat sheet 112 is firstly wound around four panels 62 of mandrel body 54 (FIGS. 7 and 9), and pump 40 is activated to create suction force through air suction pipes 72 and vents 71 in panel 62. Thus, flat sheet 112 is securely sucked to panel 62 without using any tape, which is convenient to ejection of paper box body after formation. Then, corrugated paper layer 66 is wound around flat sheet 112, and power device 44 is activated to rotate mandrel 24, winding corrugated paper layer 66 around panels 62 of mandrel body 54 to the desired rounds so as to obtain a paper box body 114 having the desired thickness (FIG. 10). Glue is applied to wavy sheet 70 of corrugated paper layer 66 to bond wavy sheet 70 with flat sheet 68. Next, pressing device 26 is moved to a position in which mandrel 24 is received in tunnel 86 of frame 78. First driving units 94 are activated to move pressing plates 88 towards mandrel body 54 and to press against paper box body 114 (FIG. 11). The glue on wavy sheet 70 is dried and causes secure bonding of wavy sheet 70 with flat sheets 68 and 112. Then, second driving units 104 are activated to move pressing rods 102 towards mandrel body 54. Pressing rods 102 press against four corners of paper box body 114 (FIG. 12), forming a recessed portion 116 in each of four corners of paper box body 114 (FIG. 14). Pressing plates 88 and pressing rods 102 are then returned to their initial positions (FIG. 13). Pull plates 108 come in contact with paper box body 114 while pressing device 26 is moving away from mandrel 24, causing ejection of paper box body 114 from the mandrel 24 (FIG. 13) and completing formation of paper box body 114.

Paper box forming machine 20 can rapidly form an integral paper box and has simple structure. Paper box body 114 formed by paper box forming machine 20 has no seams in four sides thereof and has sufficient rigidity. Furthermore, by inwardly pressing recessed portions 116 in the four corners of paper box body 114, paper box body 114 can be collapsed to reduce the volume for storage purposes.

Although specific embodiments have been illustrated and described, numerous modifications and variations are still possible without departing from the essence of the invention. The scope of the invention is limited by the accompanying claims.

1. A paper box forming machine comprising:
a machine body (22) including an axle (28) extending along a longitudinal axis;
a mandrel (24) rotatably mounted around the axle (28), with the mandrel (24) including an outer periphery surrounding the longitudinal axis, with a corrugated paper layer (66) adapted to be wound around the outer periphery of the mandrel (24); and
a pressing device (26) movable relative to the mandrel (24) along the longitudinal axis, with the pressing device (26) including a frame (78) having upper and lower portions (80, 82), with the frame (78) further including first and second side portions (84) extending between the upper and lower portions (80, 82), with a tunnel (86) extending from the first side portion (84) through the second side portion (84) along the longitudinal axis, with the tunnel (86) having a size larger than the mandrel (24), with the a pressing plate (88) provided to an inner side of each of the upper and lower portions (80, 82) and the first and second side portions (84), with the pressing plates (88) being actuatable to move relative to and in the frame (78) to exert pressure on the outer periphery of the mandrel (24),
wherein with the corrugated paper layer (66) wound around the outer periphery of the mandrel (24), the pressing device (26) is moved to a position in which the mandrel (24) is received in the tunnel (86) of the frame (78), and the pressing plates (88) are actuated to exert pressure on the outer periphery of the mandrel (24) to make a paper box body (114) from the corrugated paper layer (66) wound around the outer periphery of the mandrel (24).

2. The machine as claimed in claim 1, with the pressing device (26) further including four pressing rods (102) provided in four corners of the tunnels (86) of the frame (78), with each of the four pressing rods (102) being actuatable to move in the frame (78) to exert pressure on four corners of the mandrel (24), forming a recessed portion (116) on each of four corners of the paper box body (114).

3. The machine as claimed in claim 2, with the pressing device (26) further including a pull plate (108) located on a front end of at least one of the pressing plates (88), with the pull plate (108) coming in contact with the paper box body (114) while the pressing device (26) is moving away from the mandrel (24), causing ejection of the paper box body (114) from the mandrel (24).

4. The machine as claimed in claim 3, with the mandrel (24) including a mandrel body (54) and four panels (62) on four sides of the mandrel body (54), with the corrugated paper layer (66) adapted to be wound around the four panels (62), with the axle (28) including front and rear sections (30, 32) spaced along the longitudinal axis, with the axle (28) including a longitudinal hole (34) extending from the front section (30) through the rear section (32), with the front section (30) including a plurality of through-holes (36) in communication with the longitudinal hole (34), with the rear section (32) of the axle (28) connected by a pipe (42) to a pump (40), with the pipe (42) in communication with the longitudinal hole (34).

5. The machine as claimed in claim 4, with two spaced bearings (38) provided on the front section (30) of the axle (28), with a sleeve (56) received in the mandrel body (54) and mounted around the two bearings (38), with the sleeve (56) including a plurality of through-holes (60) extending in a radial direction perpendicular to the longitudinal axis, with one of the four panels (62) including a plurality of vents (71), with the mandrel (24) further including a plurality of air suction pipes (72) each having two ends mounted to an inner side of the one of the four panels (62) having the vents (71), with each of the two ends of each of the plurality of air suction pipes (72) having an air suction hole (74) in communication with the plurality of vents (71), with a connection section (76) extending from each of the plurality of air suction pipes (72) and being in communication with one of the through-holes (60) of the sleeve (56),
wherein with the pump (40) in operation, suction force is provided to an outer side of the panel (62) having the vents (71) through the through-holes (36) of the axle (28) and the plurality of air suction pipes (72).

6. The machine as claimed in claim 5, with the machine body (22) including a bottom having two spaced tracks (52), with each of the two spaced tracks (52) extending along the longitudinal axis, with the pressing device (26) mounted on and movable along the two tracks (52).

7. The machine as claimed in claim 6, with each of the pressing plates (88) including a plane inner face (90) and an outer face (92) opposite to the inner face (90), with the outer face (92) of each of the pressing plates (88) operably connected to and actuatable by an actuating rod (96) of a driving unit (94), with the driving units (94) actuating the pressing plates (88) to move in the frame (78) and to exert pressure on the outer periphery of the mandrel (24).
